(19) United States
(12) Patent Application Publication
(10) Pub. No.: US 2002/0118253 A1
(43) Pub. Date: Aug. 29, 2002

(54) Ink jet head having improved pressure chamber and its manufacturing method

(75) Inventors: Kenichi Ohno, Tokyo (JP); Kenichiro Suzuki, Tokyo (JP); Yuji Akimoto, Tokyo (JP); Torahiko Kanda, Tokyo (JP); Yasuhiro Otsuka, Tokyo (JP)

Correspondence Address: Patent Group, Hutchins, Wheeler & Dittmar, 101 Federal Street, Boston, MA, 02110, US

(73) Assignee: NEC Corporation

(21) Appl. No.: 09/798,372

(22) Filed: Mar. 2, 2001

(30) Foreign Application Priority Data
Mar. 21, 2000 (JP) 2000-078900

(51) Int. Cl. B41J 2/14; B41J 2/16

(52) U.S. Cl. 347/47

(57) ABSTRACT

In an ink jet head including a substrate having a opening for a pressure chamber, a section of the opening is gradually increased from a front surface of the substrate to an intermediate level of the substrate and is gradually decreased from the intermediate level of the substrate to a back surface of the substrate. The opening at the front surface of the substrate serves as a nozzle.

### BACKGROUND OF THE INVENTION

1. Field of the Invention

The present invention relates to an ink jet head and its manufacturing method.

2. Description of the Related Art

A prior art ink jet head is constructed by a stainless steel substrate or a monocrystalline silicon substrate having a straight nozzle and a tapered or bell-type pressure chamber which are formed by a mechanical press process, an etching process, an electrical discharge process or a laser process (see JP-A-9-76492 & JP-A-9-57891). This will be explained later in detail.

In the above-mentioned prior art ink jet head, however, if the pressure chamber is formed by an etching process independent of the nozzle, misalignment of the pressure chamber with respect to the nozzle may occur, which would decrease the manufacturing yield. Also, since the angle of the pressure chamber at its bottom is acute, ink stagnation may occur therein, and also, bubbles may remain therein. Further, since the substrate has to be thin, the ink jet head cannot excel at handing when assembling it into ink jet apparatuses.

### SUMMARY OF THE INVENTION

It is an object of the present invention to improve the manufacturing yield of ink jet heads.

Another object is to improve the ink stagnation characteristics and the like of ink jet heads.

A further object is to be able to thicken ink jet heads.

According to the present invention, in an ink jet head including a substrate having an opening for a pressure chamber, a section of the opening is gradually increased from a front surface of the substrate to an intermediate level of the substrate and is gradually decreased from the intermediate level of the substrate to a back surface of the substrate. The opening at the front surface of the substrate serves as a nozzle.

Also, in a method for manufacturing an ink jet head, an impurity diffusion layer is formed on at least one of front back surfaces of a silicon substrate, and an etching mask layer having a opening for a nozzle is formed on a front surface of the silicon substrate. Then, an anisotropic dry etching process is performed upon the silicon substrate using the etching mask layer as a mask and the impurity diffusion layer as an etching stopper. Finally, an anisotropic wet etching process is performed upon the silicon substrate to form a pressure chamber therein.

Further, in a method for manufacturing an ink jet head, a first etching mask layer having a first opening for a nozzle is formed on a front surface of a silicon substrate, and a second etching mask layer having a second opening is formed in correspondence with the first opening on a back surface of the silicon substrate. Then, an anisotropic dry etching process is performed upon the silicon substrate using the first and second etching mask layer as a mask. Finally, an anisotropic wet etching process is performed upon the silicon substrate to form a pressure chamber therein.

### BRIEF DESCRIPTION OF THE DRAWINGS

The present invention will be more clearly understood from the description set forth below, as compared with the prior art, with reference to the accompanying drawings, wherein:

FIG. 1 is a plan view illustrating a prior art ink jet head;

FIG. 2 is a partially-enlarged view of the ink jet head of FIG. 1;

FIGS. 3A and 3B are cross-sectional views taken along the line III-III of FIG. 2;

FIGS. 4A through 4I are cross-sectional views for explaining a first embodiment of the method for manufacturing an ink jet head according to the present invention; and

FIGS. 5A through 5I are cross-sectional views illustrating modifications of FIGS. 4A through 4I;

FIGS. 6A through 6G are cross-sectional views for explaining a second embodiment of the method for manufacturing an ink jet head according to the present invention; and

FIGS. 7A through 7G are cross-sectional views illustrating modifications of FIGS. 6A through 6G.

### DESCRIPTION OF THE PREFERRED EMBODIMENTS

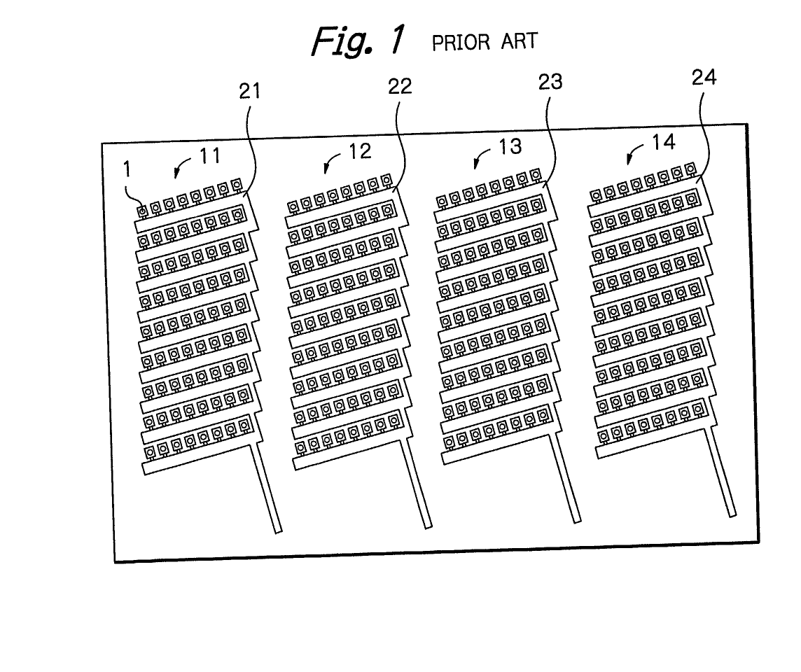

Before the description of the preferred embodiments, a prior art ink jet head will be explained with reference to FIGS. 1, 2, 3A and 3B.

In FIG. 1, which illustrates a prior art ink jet head, four nozzle columns 11, 12, 13 and 14 where nozzles 1 are closely arranged in a matrix are provided. The nozzle columns 11, 12, 13 and 14 are used for ejecting black ink, yellow ink, cyan ink and magenta ink, respectively. The nozzle columns 11, 12, 13 and 14 are linked to comb-shaped ink pools (reservoirs) 21, 22, 23 and 24, respectively, which are also linked to an ink cartridge (not shown).

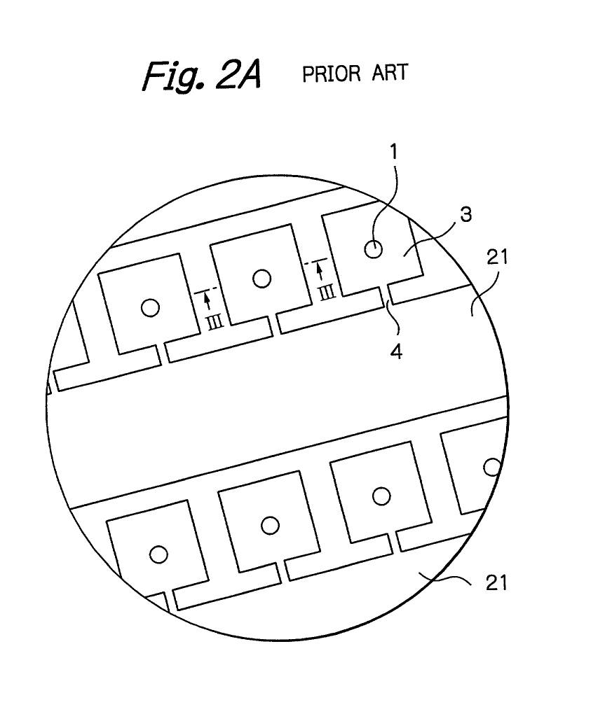

In FIG. 2, which is a partly-enlarged view of the ink jet head of FIG. 1, a pressure chamber 3 is linked to one of the nozzles 1, and an ink passage 4 is linked between the pressure chamber 3 and the ink pool such as 21.

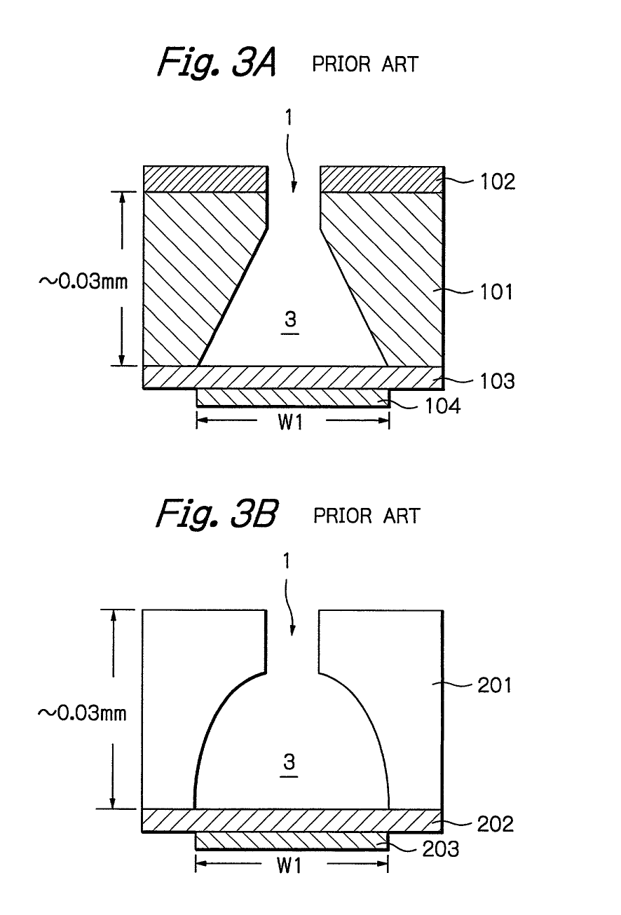

In FIG. 3A, which is a cross-sectional view taken along the line III-III of FIG. 2 (see JP-A-9-76492), reference numeral 101 designates a stainless steel substrate having a straight nozzle 1 and a tapered pressure chamber 3 which are formed by a mechanical press process, an etching process, an electrical discharge process or a laser process. Also, a plating layer 102 is formed on a front surface of the stainless steel substrate 101. On the other hand, a vibration plate 103 is adhered to a back surface of the stainless steel substrate 101, to partition the pressure chamber 3 as well as the ink pools 21, 22, 23 and 24 (see FIG. 1). Further, one actuator 104 made of piezoelectric material sandwiched by metal electrodes is adhered by a contact bonding process to the vibration plate 103 in correspondence with the nozzle 1.

In FIG. 3B, which is another cross-sectional view taken along the line III-III of FIG. 2 (see JP-A-9-57981), reference numeral 201 designates a monocrystalline silicon substrate having a straight nozzle 1 and a bell-type pressure chamber 3. In this case, the straight nozzle 1 is formed by an anisotropic dry etching process, and the bell-type chamber 3 is formed by an isotropic dry etching process. Also, a vibration plate 202 is adhered to a back surface of the monocrystalline silicon substrate 201, to partition the pressure chamber 3 as well as the ink pools 21, 22, 23 and 24 (see FIG. 1). Further, one actuator 203 made of piezoelectric material sandwiched by metal electrodes is adhered by a contact bonding process to the vibration plate 202 in correspondence with the nozzle 1.

In the ink jet head as illustrated in FIGS. 1, 2, 3A and 3B, however, if the pressure chamber 3 is formed by an etching process independent of the nozzle 1, misalignment of the pressure chamber 3 with respect to the nozzle 1 may occur, which would decrease the manufacturing yield. Also, since the angle of the pressure chamber 3 at the vibration plate 103 (102) is acute, ink stagnation may occur therein, and also, bubbles may remain therein. Further, since the substrate 101 (201) has to be thin, the ink jet heads cannot excel at handing when assembling them into ink jet apparatuses. For example, if the width W1 of the pressure chamber 3 at the vibration plate 103 (202) is 400 μm, the thickness of the substrate 101 (201) has to be smaller than 0.3 mm.

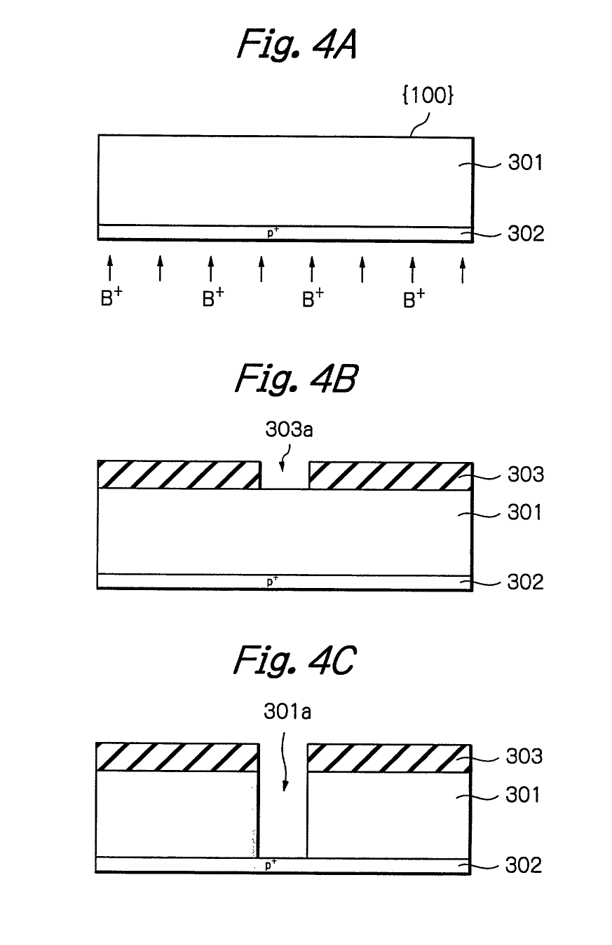

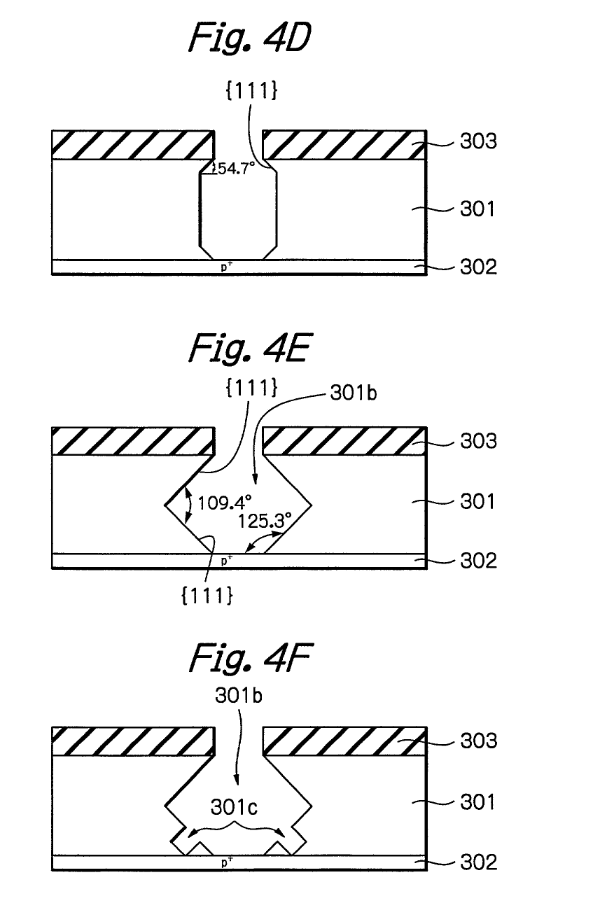

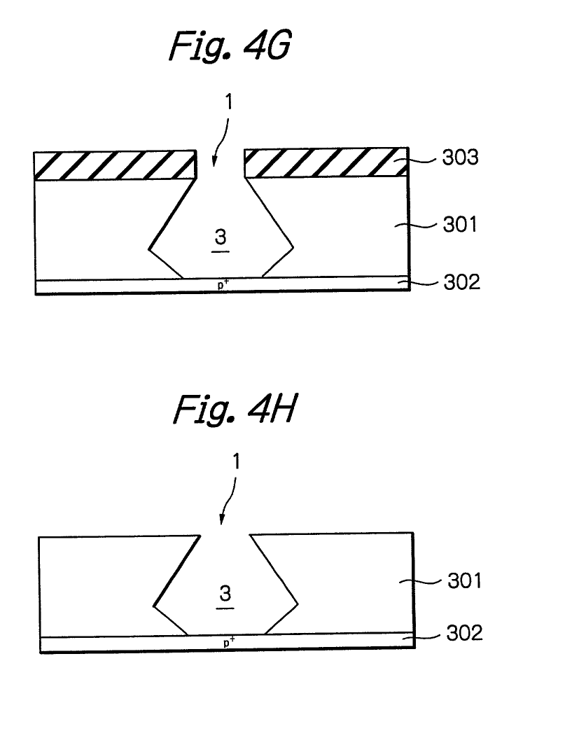

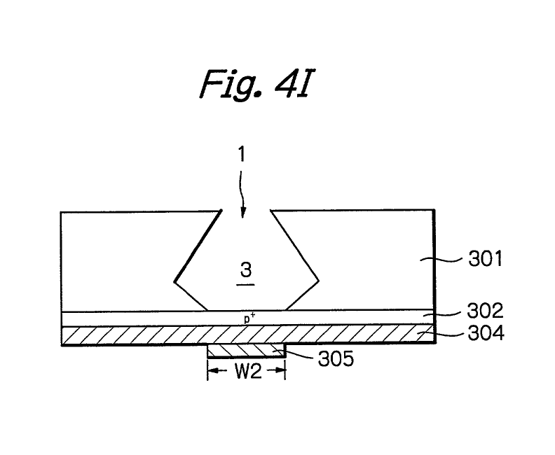

A first embodiment of the method for manufacturing an ink head will be explained next with reference to FIGS. 4A through 4I.

First, referring to FIG. 4A, p⁺-type impurities such as boron ions are implanted into a back surface of a monocrystalline silicon substrate 301 having a {100} face. As a result, a p⁺-type impurity diffusion layer 302 is formed on the back surface of the monocrystalline silicon substrate 301.

Next, referring to FIG. 4B, an insulating layer 303 made of silicon oxide or silicon nitride is deposited by a chemical vapor deposition (CVD) process on a front surface of the monocrystalline silicon substrate 301. In this case, if the insulating layer 303 is made of silicon oxide, the insulating layer 303 can be formed by thermally oxidizing the monocrystalline silicon substrate 301. Then, an opening 303a is perforated in the insulating layer 303 by a photolithography and etching process.

Next, referring to FIG. 4C, the monocrystalline silicon substrate 301 is etched by an anisotropic dry etching process using the insulating layer 303 as a mask and using the p⁺-type impurity diffusion layer 302 as an etching stopper. For example, this anisotropic dry etching process is a reactive ion etching (RIE) process using a mixture gas of CF₃/O₂. As a result, an opening 301a corresponding to the nozzle 1 is perforated in the monocrystalline silicon substrate 301.

Next, referring to FIG. 4D, an anisotropic wet etching process is carried out by using ethylenediaminepyrocatechol (EDP) water or tetramethylammoniumhydroxide (TMAH) water. As a result, the sidewall of the monocrystalline silicon substrate 301 is etched to expose {111} faces whose angle is 54.7° . When this anisotropic wet etching process is further carried out, a diamond-shaped opening 301b as illustrated in FIG. 4E is perforated in the monocrystalline silicon substrate 301. In this case, the opening 301b has two {111} faces angled at 109.4°. Therefore, the angle of the {111} face of the opening 301a on the p⁺-type impurity diffusion layer 302 with respect thereto is 125.3°. Note that the opening 301b is in self-alignment with the opening 301a, i.e., the nozzle 1, and the width of the opening 301b at its bottom is approximately the same as the width of the opening 303a of FIG. 4C.

Next, referring to FIG. 4F, the monocrystalline silicon substrate 301 is obliquely etched by an anisotropic dry etching process using the insulating layer 303 as a mask. For example, this anisotropic dry etching process is an RIE process using a mixture gas of CF₃/O₂. As a result, an opening 301c is perforated in the {111} face of monocrystalline silicon substrate 301 on the bottom side.

Next, referring to FIG. 4G, an anisotropic wet etching process using EDP water or TMAH water is again carried out. As a result, the sidewall of the monocrystalline silicon substrate 301 is further etched to expose the {111} faces. Thus, a barrel-shaped pressure chamber 3 is perforated in the monocrystalline silicon substrate 301. In this case, the angle of the {111} face of the opening 301a on the P⁺-type impurity diffusion layer 302 with respect thereto is 125.3°, i.e., obtuse. Note that the pressure chamber 3 is in self-alignment with the opening 301a, i.e., the nozzle 1, and the width of the pressure chamber 3 at its bottom is larger than the width of the opening 303a of FIG. 4C.

Next, referring to FIG. 4H, the insulating layer 303 is removed by a wet etching process using fluoric acid or phosphoric acid.

Finally, referring to FIG. 4I, a vibration plate 304 is adhered to the p⁺-type impurity diffusion layer 302, and one actuator 204 made of piezoelectric material sandwiched by metal electrodes is adhered by a contact bonding process to the vibration plate 303 in correspondence with the nozzle 1.

In the ink jet head as illustrated in FIGS. 4A through 4I, since the pressure chamber 3 is in self-alignment with the nozzle 1, misalignment of the pressure chamber 3 with respect to the nozzle 1, does not occur, which would increase the manufacturing yield. Also, since the angle of the pressure chamber 3 at the vibration plate 304 is obtuse, ink stagnation may not occur therein, and also, bubbles hardly remain therein. Further, since the cross-section is gradually increased in an upper portion of the pressure chamber 3 and is gradually decreased in a lower portion of the pressure chamber 3, the substrate 301 can be thicker, so that the ink jet heads can excel at handing when assembling them into ink jet apparatuses. For example, if the width W2 of the pressure chamber 3 at the vibration plate 304 is 400 μm, the thickness of the substrate 301 can be larger than 0.3 mm.

Additionally, in the ink jet head as illustrated in FIGS. 4A through 4I, since the p⁺-type impurity diffusion layer 302 is conductive, the ink jet head can be prevented from being electrified even when the nozzle 1 is subjected to a wiping operation for cleaning.

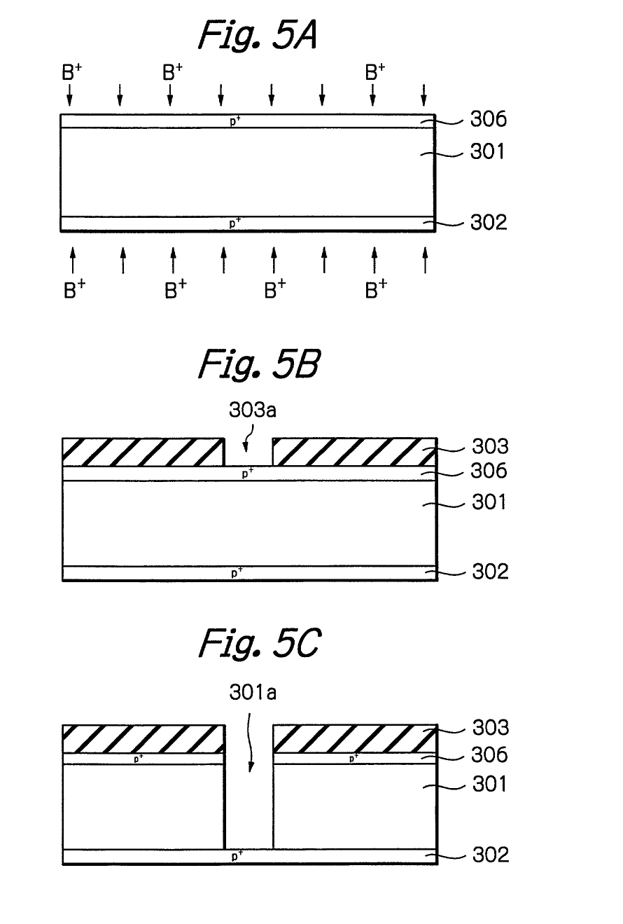

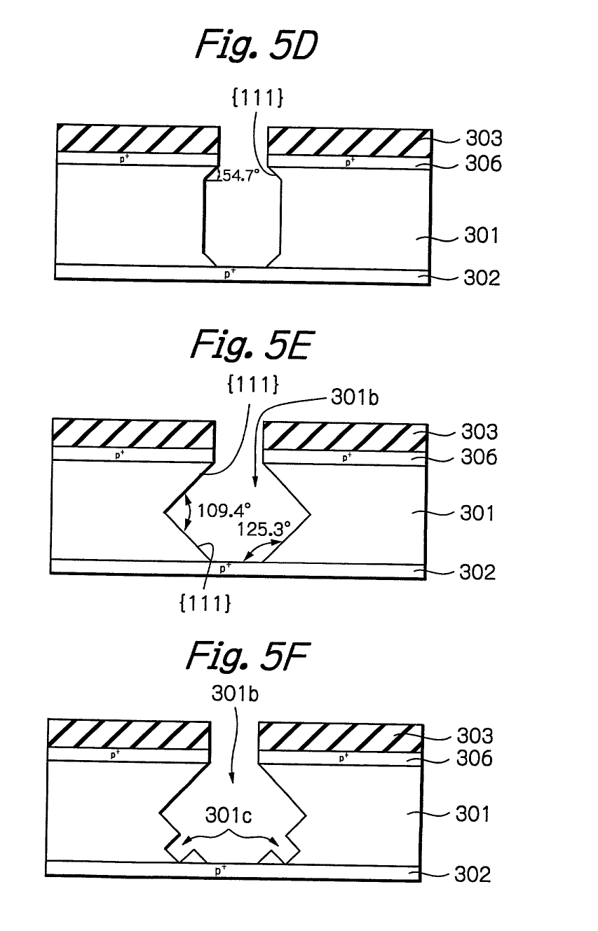

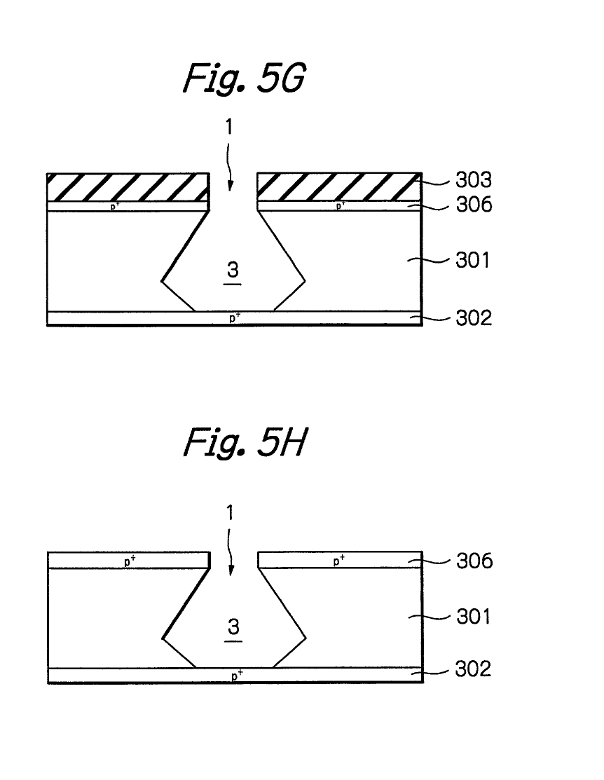

In FIGS. 5A through 5I, which illustrate modifications of FIGS. 4A through 4I, a p⁺-type impurity diffusion layer such as a boron-doped diffusion layer 306 is added on the front surface of the monocrysalline silicon substrate 1.

First, referring to FIG. 5A, after a p⁺-type impurity diffusion layer 306 is formed on the back surface of the monocrystalline silicon substrate 1, a p⁺-type impurity diffusion layer 306 is formed on the front surface of the monocrystalline silicon substrate 1.

Next, referring to FIGS. 5B, 5C, 5D, 5E, 5F, 5G, 5H and 5I, the same processes as illustrated in FIGS. 4B, 4C, 4D, 4E, 4F, 4G, 4H and 4I, respectively, are carried out. In this case, in FIG. 5C, although the etching selectivity of the p⁺-type impurity diffusion layer 306 by the anisotropic dry etching process is low, the p⁺-type impurity diffusion layer 306 can be etched due to the sufficient thickness of the insulating layer 303.

In the ink jet head as illustrated in FIGS. 5A through 5I, since the p⁺-type impurity diffusion layer 306 is also conductive, the ink jet head can be further prevented from being electrified when the nozzle 1 is subjected to a wiping operation for cleaning.

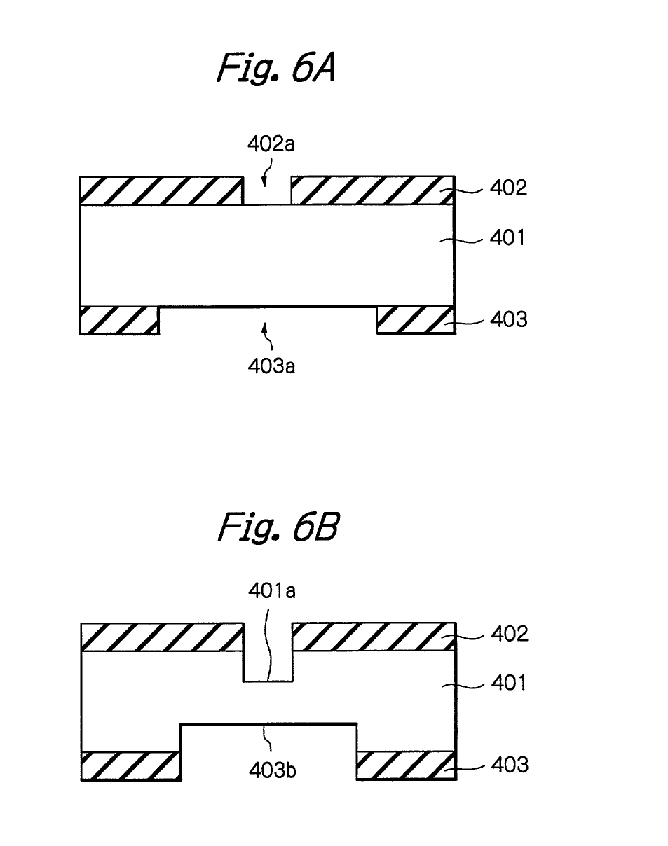

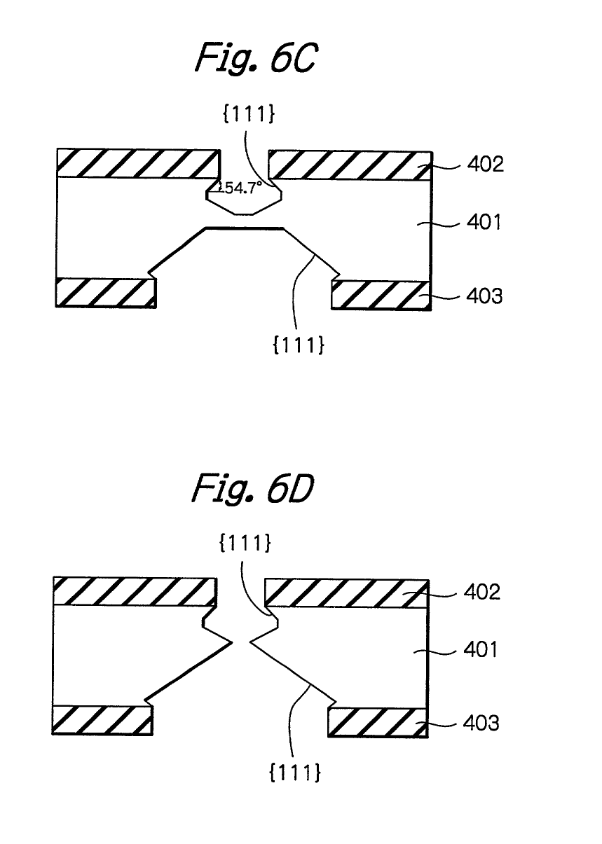

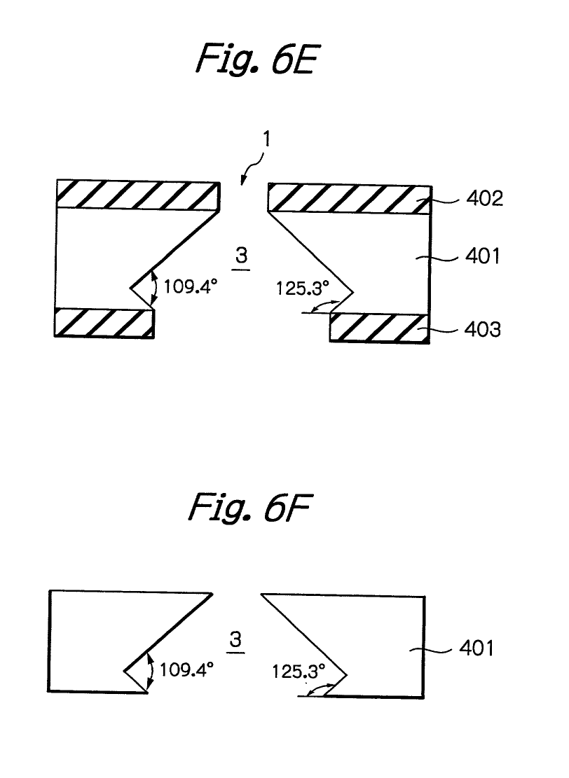

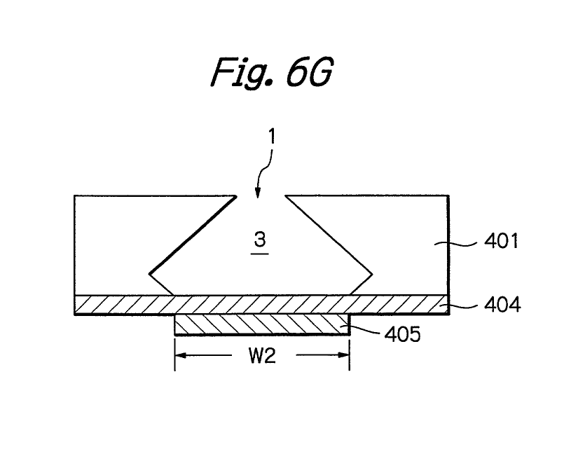

A second embodiment of the method for manufacturing an ink head will be explained next with reference to FIGS. 6A through 6G.

First, referring to FIG. 6A, insulating layers 402 and 403 made of silicon oxide or silicon nitride are deposited by a CVD process on front and back surfaces, respectively, of a monocrystalline silicon substrate 401 having a {100} face. In this case, if the insulating layers 402 and 403 are made of silicon oxide, the insulating layers 402 and 403 can be formed by thermally oxidizing the monocrystalline silicon substrate 401. Then, opening 402a and 403a are perforated in the insulating layers 402 and 403, respectively, by a photolithography and etching process. In this case, the opening 403a is wider than the opening 402a.

Next, referring to FIG. 6B, the front and back surfaces of the monocrystalline silicon substrate 401 are etched by an anisotropic dry etching process using the insulating layers 402 and 403 as a mask. For example, this anisotropic dry etching process is an RIE process using a mixture gas of CF₃/O₂. As a result, an opening 401a corresponding to the nozzle 1 and an opening 402a corresponding to the pressure chamber 3 are perforated in the monocrystalline silicon substrate 401.

Next, referring to FIG. 6C, an anisotropic wet etching process is carried out by using EDP water or TMAH water. As a result, the sidewall of the monocrystalline silicon substrate 301 is etched to expose {111} faces which are angled at 54.7°. When this anisotropic wet etching process is further carried out as illustrated in FIG. 6D, a barrel-shaped opening corresponding to the pressure chamber 3 as illustrated in FIG. 6E is perforated in the monocrystalline silicon substrate 401. In this case, the pressure chamber 3 has two {111} faces angled at 109.4°. Therefore, the angle of the {111} face of the pressure chamber 3 on the insulating layer 403 with respect thereto is 125.3°, i.e., obtuse.

Note that the upper portion of the pressure chamber 3 is in self-alignment with the nozzle 1, and the width of the pressure chamber 3 at its bottom is larger than that of the nozzle 1.

Next, referring to FIG. 6F, the insulating layers 402 and 403 are removed by a wet etching process using fluoric acid or phosphoric acid.

Finally, referring to FIG. 6G, a vibration plate 404 is adhered to the insulating layer 403, and one actuator 404 made of piezoelectric material sandwiched by metal electrodes is adhered by a contact bonding process to the vibration plate 403 in correspondence with the nozzle 1.

Even in the ink jet head as illustrated in FIGS. 6A through 6G, since the pressure chamber 3 is in self-alignment with the nozzle 1, misalignment of the pressure chamber 3 with respect to the nozzle 1 does not occur, which would increase the manufacturing yield. Also, since the angle of the pressure chamber 3 at the vibration plate 404 is obtuse, ink stagnation may not occur therein, and also, bubbles hardly remain therein. Further, since the cross-section is gradually increased in an upper portion of the pressure chamber 3 and is gradually decreased in a lower portion of the pressure chamber 3, the substrate 401 can be thickem, so that the ink jet heads can excel at handing when assembling them into ink jet apparatuses. For example, if the width W3 of the pressure chamber 3 at the vibration plate 404 is 400 μm, the thickness of the substrate 401 can be larger than 0.3 mm.

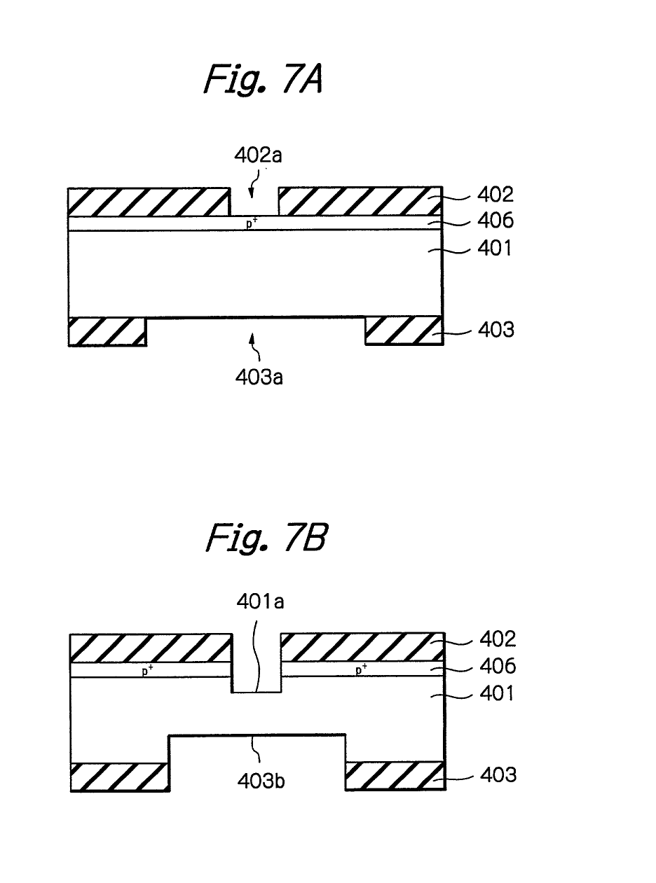

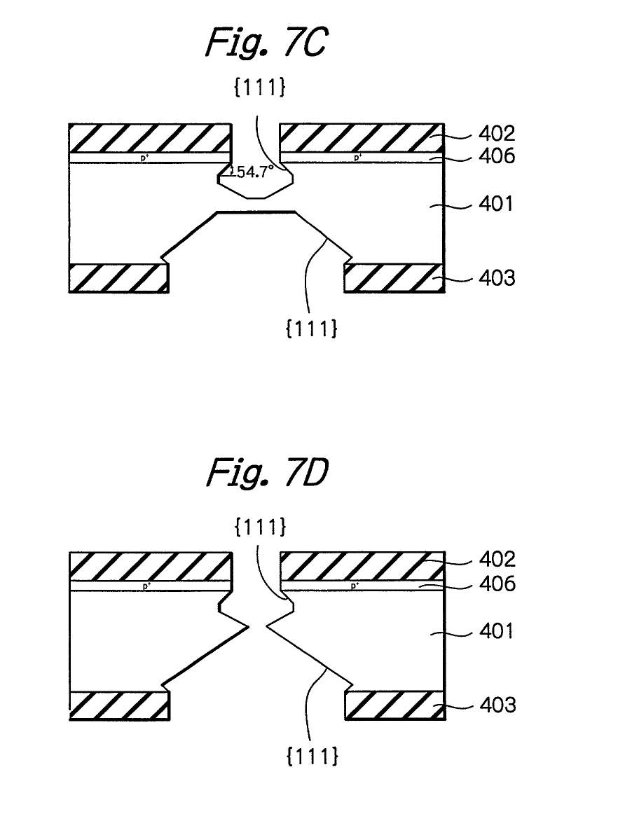

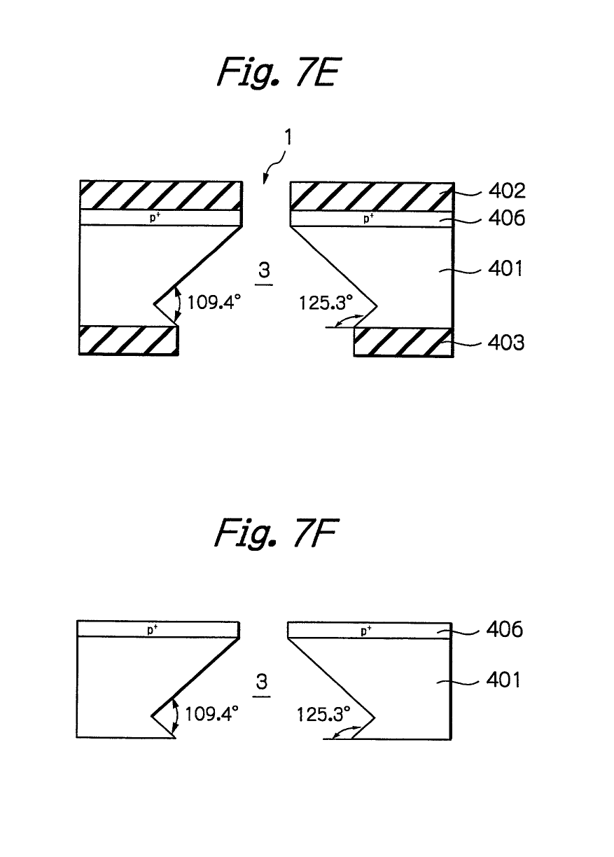

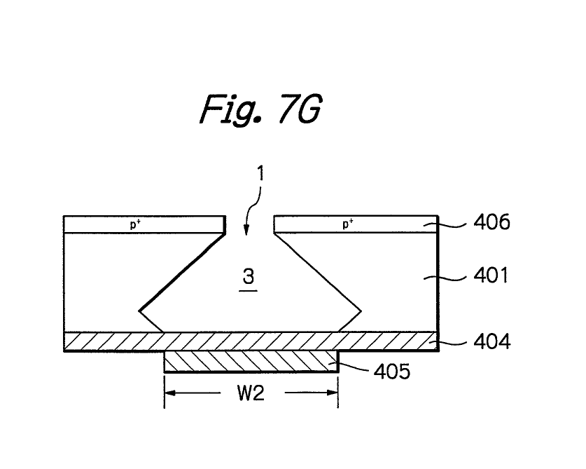

In FIGS. 7A through 7G, which illustrate modifications of FIGS. 6A through 6G, a p⁺-type impurity diffusion layer such as a boron-doped diffusion layer 406 is added on the front surface of the monocrysalline silicon substrate 1.

First, referring to FIG. 7A, before the insulating layers 402 and 403 are formed on the front and back surfaces of the monocrystalline silicon substrate 1, a p⁺-type impurity diffusion layer 406 is formed on the front surface of the monocrystalline silicon substrate 1.

Next, referring to FIGS. 7B, 7C, 7D, 7E, 7F and 7G, the same processes as illustrated in FIGS. 6B, 6C, 6D, 6E, 6F and 6G, respectively, are carried out. In this case, in FIG. 7B, although the etching selectivity of the p⁺-type impurity diffusion layer 406 by the anisotropic dry etching process is low, the p⁺-type impurity diffusion layer 406 can be etched due to the sufficient thickness of the insulating layer 402.

In the ink jet head as illustrated in FIGS. 7A through 7G, since the p⁺-type impurity diffusion layer 406 is conductive, the ink jet head can be prevented from being electrified when the nozzle 1 is subjected to a wiping operation for cleaning.

As explained hereinabove, according to the present invention, the manufacturing yield can be increased. Also, the ink stagnation characteristics and the bubble exhausting characteristics can be improved. Further, since the substrate can be thicker, the ink jet head can excel at handling.

1. An ink jet head comprising a substrate having a first opening for a pressure chamber, wherein a section of said first opening being gradually increased from a front surface of said substrate to an intermediate level of said substrate and gradually decreased from the intermediate level of said substrate to a back surface of said substrate,
said first opening at the front surface of said substrate serving as a nozzle.

2. The ink jet head as set forth in claim 1, further comprising a first conductive layer formed on the front surface of said substrate, said first conductive layer having a second opening for said nozzle leading to said first opening.

3. The ink jet head as set forth in claim 1, further comprising a second conductive layer formed on the back surface of said substrate, said second conductive layer having a third opening leading to said first opening.

4. The ink jet head as set forth in claim 1, wherein said intermediate level is closer to the back surface of said substrate than the front surface of said substrate, so that the section of said first opening on the front surface of said substrate is smaller than the section of said first opening on the back surface of said substrate.

5. The ink jet head as set forth in claim 1, wherein said substrate is made of monocrystalline silicon having {100} faces on the front and back surfaces of said substrate and {111} faces on said first opening.

6. The ink jet head as set forth in claim 2, wherein said first conductive layer is made of impurity-doped silicon.

7. The ink jet head as set forth in claim 3, wherein said second conductive layer is made of impurity-doped silicon.

8. The ink jet head as set forth in claim 1, further comprising:
a vibration plate adhered to the back surface of said substrate; and
an actuator adhered to said vibration plate in correspondence with said nozzle.

9. The ink jet head as set forth in claim 3, further comprising:
a vibration plate adhered to said second conductive layer; and
an actuator adhered to said

10. A method for manufacturing an ink jet head, comprising the steps of:
forming an impurity diffusion layer on at least one of front and back surfaces of a silicon substrate;
forming an etching mask layer having an opening for a nozzle on a front surface of said silicon substrate;
performing an anistropic dry etching process upon said silicon substrate using said etching mask layer as a mask and said impurity diffusion layer as an etching stopper; and
performing an anisotropic wet etching process upon said silicon substrate to form a pressure chamber therein, after said anistropic dry etching process is performed.

11. The method as set forth in claim 10, wherein said impurity diffusion layer forming step implants p-type impurities into said silicon substrate.

12. The method as set forth in claim 10, wherein said etching mask layer is made of one of silicon oxide and silicon nitride.

13. The method as set forth in claim 10, wherein said silicon substrate has {100} faces on the front and back surfaces of said silicon substrate.

14. The method as set forth in claim 13, wherein said silicon substrate has {111} faces on sidewalls of said pressure chamber.

15. The method as set forth in claim 10, wherein said anisotropic wet etching process uses one of ethylenediaminepyrocatechol water and tetramethylammoniumhydroxide water.

16. The method as set forth in claim 10, further comprising the steps of:
performing an oblique anistropic dry etching process upon said silicon substrate using said etching mask layer as a mask and said impurity diffusion layer as an etching stopper, after said anisotripic wet etching process is performed; and
performing an additional anisotropic wet etching process upon said silicon substrate, after said oblique anistropic dry etching process is performed.

17. The method as set forth in claim 16, wherein said oblique anisotropic wet etching process uses one of ethylenediaminepyrocatechol water and tetramethylammoniumhydroxide water.

18. A method for manufacturing an ink jet head, comprising the steps of:
forming a first etching mask layer having a first opening for a nozzle on a front surface of a silicon substrate;
forming a second etching mask layer having a second opening in correspondence with said first opening on a back surface of said silicon substrate;
performing an anistropic dry etching process upon said silicon substrate using said first and second etching mask layer as masks; and
performing an anisotropic wet etching process upon said silicon substrate to form a pressure chamber therein, after said anistropic dry etching process is performed.

19. The method as set forth in claim 18, wherein said first opening is smaller than said second opening.

20. The method as set forth in claim 18, wherein said first and second etching mask layers are made of one of silicon oxide and silicon nitride.

21. The method as set forth in claim 18, further comprising a step of forming an impurity diffusion layer beneath at least one of said first and second etching mask layers.

22. The method as set forth in claim 18, wherein said silicon substrate has {100} faces on the front and back surface of said silicon substrate.

23. The method as set forth in claim 22, wherein said silicon substrate has {111} faces on sidewalls of said pressure chamber.

24. The method as set forth in claim 18, wherein said anisotropic wet etching process uses one of ethylenediaminepyrocatechol water and tetramethylammoniumhydroxide water.
